(19) United States
(12) Patent Application Publication
(10) Pub. No.: US 2006/0037248 A1
(43) Pub. Date: Feb. 23, 2006

(54) Sliding member for power window devices in motor vehicles

(76) Inventor: Melchor Daumal Castellon, Barcelona (ES)

Correspondence Address: BLANK ROME LLP, 600 NEW HAMPSHIRE AVENUE, N.W., WASHINGTON, DC, 20037, US

(21) Appl. No.: 11/152,112

(22) Filed: Jun. 15, 2005

(30) Foreign Application Priority Data
Aug. 18, 2004 (ES) 200401987 U

(51) Int. Cl. B60J 1/16

(52) U.S. Cl. 49/374

(57) ABSTRACT

A sliding member that moves along a guide rail holding the window pane lower edge and has a transverse adjustment threaded element transversely received into the sliding member within a threaded hole thereof causing the position of the window pane to be adjusted in one substantially perpendicular direction thereto; a fastening screw transversely inserted into the sliding member within a further hold thereof passing through a slot in the window pane and inserted into the sliding member allowing the position of said window pane to be adjusted in one substantially horizontal direction; and a vertical adjustment threaded element threadingly received into a body formed integrally with the sliding member, allowing the window pane to be adjusted in one substantially vertical direction.

The invention relates to a sliding member for power window devices in motor vehicles which novel features provide many advantages, as it will be detailed in the present specification.

The basic configuration of a power window device for a motor vehicle, whether it is manually or electrically driven, basically consists of a movable window pane, window pane driving means and window pane fastening means. Window pane fastening means support said window pane through its lower end by means of at least one gripping member that is attached to a sliding or dragging member running along a guide rail.

When assembling the power window device, as well as in operations of maintenance, it is of great importance to be able to properly adjust the position of the window pane in the power window device with the purpose of correcting errors of deformation in the motor vehicle door bodywork and, in turn, ensuring the sealing conditions of the assembly.

Due to this necessity for being able to adjust the power window device, adjusting devices for power window systems have been proposed in the art. The owner of the present invention is also the owner of several patents and utility models relating to devices which purpose is to provide a higher adaptability of the window pane in the door of the vehicle. These devices are based, for example, on the fact that the two points of attachment of the guide rail to the door may be moved in a traverse direction thereto with the purpose of slightly rotating the assembly around the other point of attachment that is fixed for properly adjusting the position of the window pane in the frame of the door when assembling the power window device. They are, therefore, devices for lateral adjustment of the power window device through the guide rail, the lower point of attachment of the guide rail to the door usually being the one that is moved in traverse direction thereto.

These devices have been shown very effective and reliable in adjusting the relative position of the power window device to the door through the rail. However, on many occasions there is a limited freedom of movement of the rail in the door for reasons of space and geometries, its movement being complicated once assembled.

The invention provides a new solution in which said guide rail is now fixed. For this purpose, is the sliding member of the power window device that is provided with means for adjusting the position thereof relative to the guide rail. Specifically, these means for adjusting the position of the sliding member herein provided basically comprise:
a transversely adjusting threaded element transversely received into the sliding member within a threaded hole thereof. The inner end of said adjusting threaded element acts on a resilient inner surface of the sliding member leaning it and therefore resulting in the window pane adjustment in one leaning direction substantially perpendicular thereto;
a fastening screw that is transversely inserted into the sliding member within a further hole thereof. This screw passes through a slot formed in the window pane inserted into the sliding member allowing the window pane to be adjusted in a substantially horizontal direction; and
a vertical adjustment threaded element threadingly received into a body formed integrally with the sliding member. The free end of such threaded element abuts an end stop located at one or both ends of the rail, thus allowing the window pane adjustment in a substantially vertical direction.

Preferably, the sliding member of the invention is provided with a torsion spring arranged surrounding the end of at least said first transverse adjustment threaded element. This torsion spring provides a permanent and stable resistive torque, which is not varied by fatigue of the material, on the contrary of what occurs in clamping devices using other means, such as nylon nuts and the like. As it is a spring elastic deformation more movements are allowed than in a plastic deformation. The torsion spring allows mechanism noises arisen from contact and vibrations of metal parts to be reduced.

There is also envisaged the option of providing a plate inserted into said sliding member in contact with said resilient inner surface of the sliding member This plate has a U-shaped cross-section end area for holding the window pane lower edge. Thus, the end of the first transverse adjustment threaded element acts on the resilient inner surface of the sliding member through said plate, which is also provided with a hole so that said fastening screw of the window pane passes therethrough.

The adjustable sliding member herein described according to the invention allows errors of deformation of motor vehicle door bodywork to be effectively corrected and sealing conditions of the assembly ensured.

The features and the advantages of the sliding member for power window devices of the present invention will be clearer from the detailed description of a preferred embodiment. This description will be given hereinafter by way of a non limitative example, with reference to the drawings.

In said drawings:

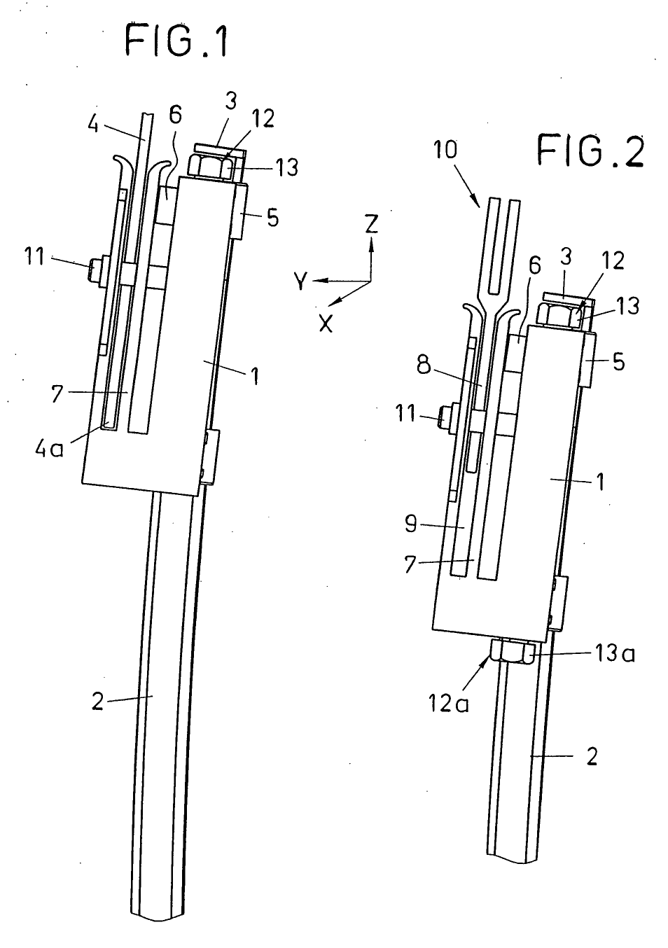

FIG. 1 is a fragmentary elevational view of a power window device rail provided with one embodiment of an adjustable sliding member according to the invention; and

FIG. 2 is a fragmentary perspective view of the power window device rail provided with an additional embodiment of the adjustable sliding member of the invention.

In both exemplary embodiments in figures according to the present invention there is provided a sliding member referenced by (1). The sliding member (1) comprises a plastic body designed to be moved along a guide rail (2), which is partly shown in both figures. The guide rail (2) includes, in one or both ends, one end stop member (3) (the upper one shown herein) with which the sliding member (1) contacts at the end of its travel through the rail (2).

The sliding member (1) of the power window device that is herein described has the purpose of holding the lower edge (4a) of the window pane (4) of the motor vehicle and imparting the upward and downward movement thereto. Therefore, the sliding member (1) is moved dragging the window pane (4) that is driven through a driving cable (not shown).

In the example shown in both figures, the sliding member (1) is provided with means for adjusting its position relative to the guide rail (2). Provision of such means for adjusting the position of the sliding member (1) allows a certain movement for adjusting the window pane (4) so that it is adapted to the vehicle door.

These adjusting means comprise a transverse adjustment threaded element (5) which, in the embodiments shown, consists of a screw. This screw (5) is threadingly received transversely into the body of the sliding member (1) within a threaded hole thereof.

As it may be seen in the embodiment in FIG. 1, the inner end (6) of the screw (5) is in contact with a resilient inner surface (7) of the sliding member body (1). The resilient inner surface (7) of the sliding member body (1) is formed in the sliding member body (1) itself and it is about 2 mm thick.

The axial movement of the screw (5) transversely to the sliding member (1) against said resilient inner surface (7) causes the adjustment of the window pane (4) in one direction (Y) substantially perpendicular thereto, causing a slight pivoting movement of the window pane (4) substantially around its lower edge (4a).

In the embodiment in FIG. 2, the inner end (6) of the screw (5) is in contact with the resilient inner surface (7) but, contrary to the embodiment in FIG. 1, this is carried out by acting at the same time on a metal plate (8). This metal plate (8) is shown in FIG. 2 and it is inserted within the space (9) where, in the embodiment in FIG. 1, the window pane (4) was received. As it may be seen from FIG. 2 of the drawings, said metal plate (8) inserted within the space (9) of the sliding member body (1) has a U-shaped cross-section upper end area (10) intended for holding the lower edge (4a) of the window pane (4) (not shown in FIG. 2).

The adjusting means also comprise a fastening screw (11) that is transversely inserted into the body of the sliding member (1) within a further hole thereof. The fastening screw (11) also passes through a slot in the window pane (4) and it is received into the sliding member (1). The arrangement of the slot of the window (4) (not shown) allows the window pane (4) to be adjusted in one substantially horizontal direction (X), that is, perpendicular to the drawing. It should be pointed out that in the embodiment in FIG. 2, the surface of the metal plate (8) is also provided with a hole so that said fastening screw (11) passes therethrough.

Finally, the means for adjusting the sliding member (1) comprise a vertical adjustment threaded element (12). Said vertical adjustment threaded element (12) is received into a body integral with the sliding member (1). In the embodiment of the figures, the vertical adjustment threaded element (12) is a screw having a head (13) abutting the end stop member (3) located at the end of the rail (2). By being threaded into the body of the sliding member (1), said vertical adjustment threaded element (12) allows the abutting distance with the rail to be adjusted and consequently adjusting the window pane in one substantially vertical direction (Z), as depicted by the coordinate axes (X, Y, Z). As shown in FIG. 2, the body of the sliding member (1) may be provided with a further vertical adjustment threaded element (12a) arranged so that its head (13a) abuts the end stop member (3) located at the opposed end of the rail (2) (not shown).

Although it is not shown, it is preferred to provide a torsion spring surrounding at least the end of the screw (5) for reducing noises in the mechanism arisen from contact and vibrations of metal parts.

With an adjustable sliding member (1) as the one herein described it is possible to effectively correct errors of deformation of the motor vehicle door bodywork and to ensure the sealing conditions of the assembly.

Once having been sufficiently described what the adjustable sliding member for power window devices of the present invention consists in accordance to the enclosed drawings, it is to be understood that any detail modification can be introduced as appropriate, unless variations may alter the essence of the invention as summarized in the appended claims.

1- Sliding member (1) for power window devices in motor vehicles adapted for being moved along a guide rail (2) including, at least at one of their ends, one end stop member (3) for said sliding member (1), said sliding member (1) being associated with the lower edge (4a) of a window pane (4) of the motor vehicle and being provided with means for adjusting its relative position, characterized in that said means for adjusting the position of the sliding member (1) comprise:
a transverse adjustment threaded element (5) that is transversely received into the sliding member (1) within a threaded hole thereof which inner end (6) acts on a resilient inner surface (7) of the sliding member (1) causing the position of the window pane (4) to be adjusted in one substantially perpendicular direction (Y) thereto producing a slight pivoting movement of said window pane (4);
a fastening screw (11) transversely inserted into the sliding member (1) within a further hole thereof passing through a slot in the window pane (4) and inserted into the sliding member (1) allowing the position of said window pane (4) to be adjusted in one substantially horizontal direction (X), and
at least one vertical adjustment threaded element (12; 12a) that is threadingly received into a body formed integrally with the sliding member (1), the free end (13; 13a) of said threaded element (12; 12a) abutting said end stop member (3) of the rail (2), allowing the window pane (4) to be adjusted in one substantially vertical direction (Z).

2- Sliding member (1) for power window devices in motor vehicles as claimed in claim 1, characterized in that it comprises a torsion spring arranged surrounding the end of at least said first transverse adjustment threaded element (5).

3- Sliding member (1) for power window devices in motor vehicles as claimed in claim 1, characterized in that it further comprises a plate (8) inserted into said sliding member (1) in contact with said resilient inner surface (7) which has a U-shaped cross-section end area (10) for holding the lower edge (4a) of the window pane (4), the inner end (6) of said first transverse adjustment threaded element (5) acting on the resilient inner surface (7) of the sliding member (1) through said plate (8) and said plate (8) having a hole so that said fastening screw (11) of the window pane (4) passes therethrough.
